(19) United States
(12) Patent Application Publication
(10) Pub. No.: US 2019/0045907 A1
(43) Pub. Date: Feb. 14, 2019

(54) SMART BAGS

(71) Applicant: Rafael A. Rodriguez, New York, NY (US)

(72) Inventor: Rafael A. Rodriguez, New York, NY (US)

(21) Appl. No.: 16/160,833

(22) Filed: Oct. 15, 2018

Related U.S. Application Data
(63) Continuation-in-part of application No. 15/959,086, filed on Apr. 20, 2018.
(60) Provisional application No. 62/488,011, filed on Apr. 20, 2017.

(51) Int. Cl. A45F 3/00; H02J 7/00; H02J 7/02; H02J 7/35; H04B 1/3827; H04R 3/00; A45F 3/04

(52) U.S. Cl. CPC A45F 3/00; H02J 7/0013; H02J 7/025; H02J 7/35; A45F 2003/003; H04R 3/00; A45F 3/04; H04R 2420/07; H04B 1/3827

(57) ABSTRACT

A smart bag includes one or more smart features that improve the use of various electronic devices by providing various features for the user. The bag may be closable by a zipper, where the zipper may be lockable. The bag can be any kind of bag, including, but not limited to, a backpack, travel luggage, purse, beach bag, gym bag, or the like. The smart features can include data storage, SIM card ports, USB ports, proximity sensors, wireless charging features, power storage and power supply features and the like.

### BACKGROUND OF THE INVENTION

The present invention relates to bags and, more particularly, to a smart bag having one or more electronic accessories built therein.

Various types of bags are known in the art. Many people, traveling with electronics, use a bag to store their device, such as a tablet computer, a laptop computer or the like.

However, typical bags lack any electronic features. Therefore, if someone wishes to listen to music from their device, they would need to use the device's speakers or a separate speaker system. Similarly, to charge their device, the user would need to carry separate charging cords.

Conventional bags are “dumb” bags and lack any electronic features for the user's benefit besides carrying or protecting their items.

As can be seen, there is a need for an improved bag that includes smart electronic features.

### SUMMARY OF THE INVENTION

Embodiments of the present invention provide a bag comprising an inner member mating with an outer member forming a space therebetween; an openable closure providing access to the space; at least one power storage apparatus removably configured in the bag; one or more charging devices configured to charge the at least one power storage apparatus; one or more power ports outputting power from the at least one power storage apparatus; and one or more wireless charging modules disposed adjacent a mobile device pocket, the one or more wireless charging modules operable to charge a mobile device disposed in the mobile device pocket.

Embodiments of the present invention further provide a bag comprising an inner member mating with an outer member forming a space therebetween; an openable closure providing access to the space; at least one power storage apparatus removably configured in the bag; one or more charging devices configured to charge the at least one power storage apparatus; a wireless communication module in the bag to permit wireless data to be sent to and from the bag; and a data storage device electronically connected to a controller in the bag, wherein the controller permits data to be stored in or accessed from the data storage device.

Embodiments of the present invention also provide a bag comprising an inner member mating with an outer member forming a space therebetween; an openable closure providing access to the space; at least one power storage apparatus removably configured in the bag; one or more charging devices configured to charge the at least one power storage apparatus; one or more power ports outputting power from the at least one power storage apparatus; one or more wireless charging modules disposed adjacent a mobile device pocket, the one or more wireless charging modules operable to charge a mobile device disposed in the mobile device pocket; one or more data storage devices electronically connected with a processor in the bag; a wireless transmitter and receiver operable to connect to a wireless signal; and a proximity alert device providing an alert to a user when the bag is beyond a preconfigured distance from the proximity alert device.

These and other features, aspects and advantages of the present invention will become better understood with reference to the following drawings, description and claims.

### BRIEF DESCRIPTION OF THE DRAWINGS

Some embodiments of the present invention are illustrated as an example and are not limited by the figures of the accompanying drawings, in which like references may indicate similar elements.

FIG. 1 is an exploded view of a smart bag according to an exemplary embodiment of the present invention;

FIG. 2 is an inside view of a storage compartment of the smart bag of FIG. 1;

FIGS. 3A and 3B show a regular perspective and an exploded perspective view of a smart phone pocket of the smart bag of FIG. 1;

FIG. 4 is a perspective view of a zipper lock for the smart bag of FIG. 1;

FIGS. 5A and 5B show a regular perspective and an exploded perspective view of a wireless speaker of the smart bag of FIG. 1;

FIG. 6 shows a detailed top view of the zipper of the smart bag of FIG. 1;

FIG. 7 shows a side perspective exploded view of the smart bag of FIG. 1; and

FIG. 8 shows a rear perspective exploded view of the smart bag of FIG. 1.

Unless otherwise indicated illustrations in the figures are not necessarily drawn to scale.

The invention and its various embodiments can now be better understood by turning to the following detailed description wherein illustrated embodiments are described. It is to be expressly understood that the illustrated embodiments are set forth as examples and not by way of limitations on the invention as ultimately defined in the claims.

### DETAILED DESCRIPTION OF THE INVENTION

The terminology used herein is for the purpose of describing particular embodiments only and is not intended to be limiting of the invention. As used herein, the term “and/or” includes any and all combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

Unless otherwise defined, all terms (including technical and scientific terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

In describing the invention, it will be understood that a number of techniques and steps are disclosed. Each of these has individual benefit and each can also be used in conjunction with one or more, or in some cases all, of the other disclosed techniques. Accordingly, for the sake of clarity, this description will refrain from repeating every possible combination of the individual steps in an unnecessary fashion. Nevertheless, the specification and claims should be read with the understanding that such combinations are entirely within the scope of the invention and the claims.

In the following description, for purposes of explanation, numerous specific details are set forth in order to provide a thorough understanding of the present invention. It will be evident, however, to one skilled in the art that the present invention may be practiced without these specific details.

The present disclosure is to be considered as an exemplification of the invention and is not intended to limit the invention to the specific embodiments illustrated by the figures or description below.

Devices or system modules that are in at least general communication with each other need not be in continuous communication with each other, unless expressly specified otherwise. In addition, devices or system modules that are in at least general communication with each other may communicate directly or indirectly through one or more intermediaries.

A description of an embodiment with several components in communication with each other does not imply that all such components are required. On the contrary, a variety of optional components are described to illustrate the wide variety of possible embodiments of the present invention.

As is well known to those skilled in the art, many careful considerations and compromises typically must be made when designing for the optimal configuration of a commercial implementation of any system, and in particular, the embodiments of the present invention. A commercial implementation in accordance with the spirit and teachings of the present invention may be configured according to the needs of the particular application, whereby any aspect(s), feature(s), function(s), result(s), component(s), approach(es), or step(s) of the teachings related to any described embodiment of the present invention may be suitably omitted, included, adapted, mixed and matched, or improved and/or optimized by those skilled in the art, using their average skills and known techniques, to achieve the desired implementation that addresses the needs of the particular application.

Broadly, an embodiment of the present invention provides a bag having one or more smart features that improve the use of various electronic devices by providing various features for the user. The bag may be closable by a zipper, where the zipper may be lockable and, in some embodiments, may be self-closing. In some embodiments, the bag can be any kind of bag, including, but not limited to, a backpack, travel luggage, purse, beach bag, gym bag, or the like.

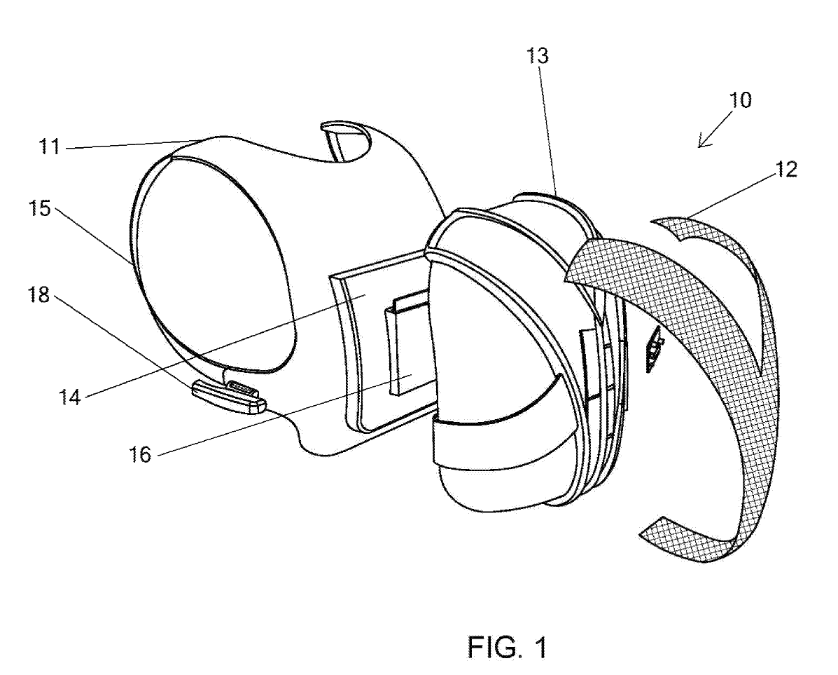

Referring to FIGS. 1 through 8, a bag 10 can be formed from an inner portion 11 and an outer portion 13 at least partially removably attached together to form storage therebetween. One or more straps 15 can extend from the inner portion 11 of the bag 10. The bag 10 can include a solar panel 12, such as a flexible solar panel, attached to the exterior to the outer portion 13 thereof. A circuit board 17 can be used to control power from the solar panel 12 and deliver power to a battery, power ports, or the like, as discussed in greater detail below.

The bag 10 can be formed from various materials, including flexible, semi-flexible or rigid materials. In some embodiments, the bag 10 can be formed from a puncture resistant material. In some embodiments, the bag 10 can be formed from a self-sealing material.

The bag 10 can include storage pockets, such as a larger storage pocket 14 for storing tablet computer, laptop computers, or the like, and a smaller storage pocket 16 for storing phones, e-readers, or the like.

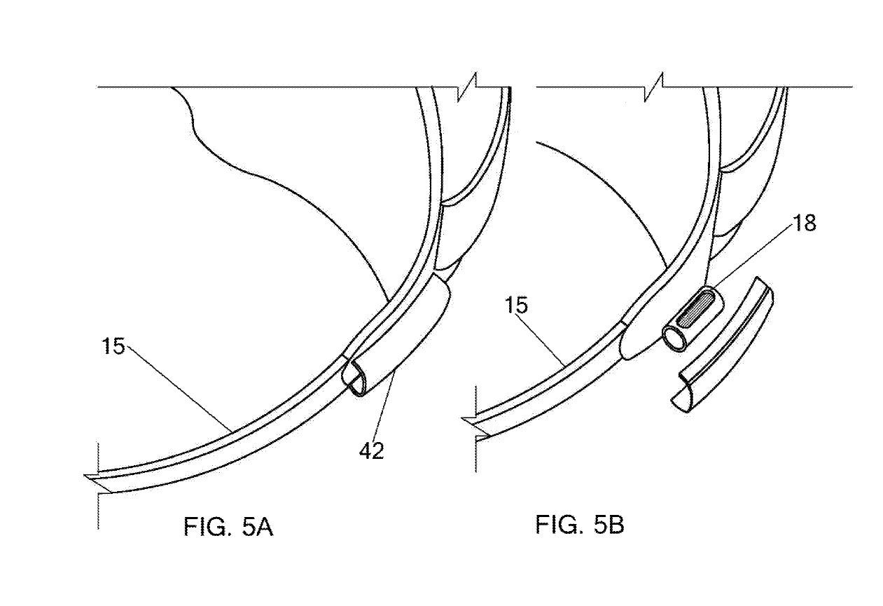

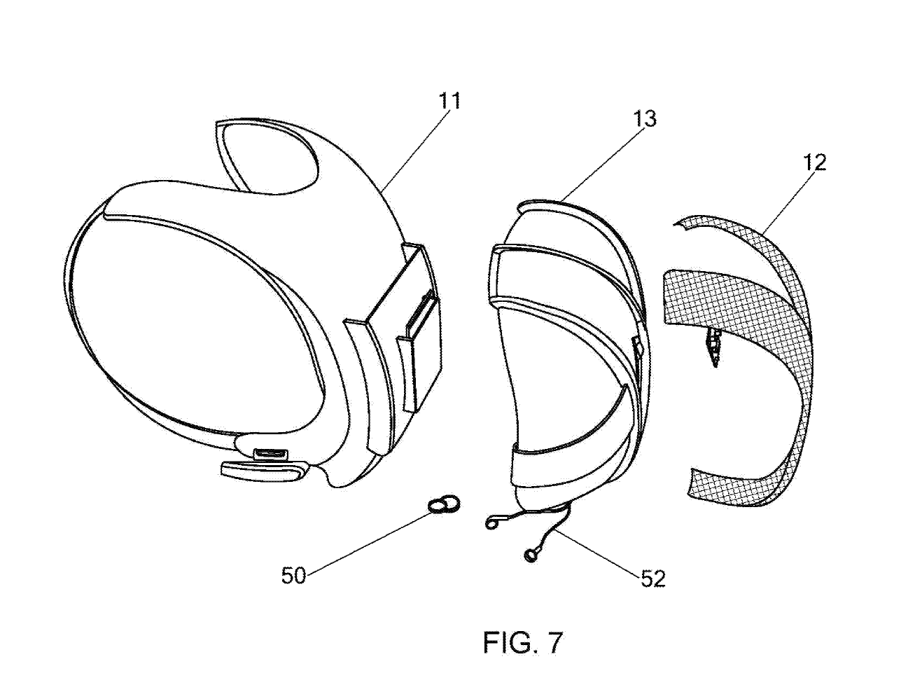

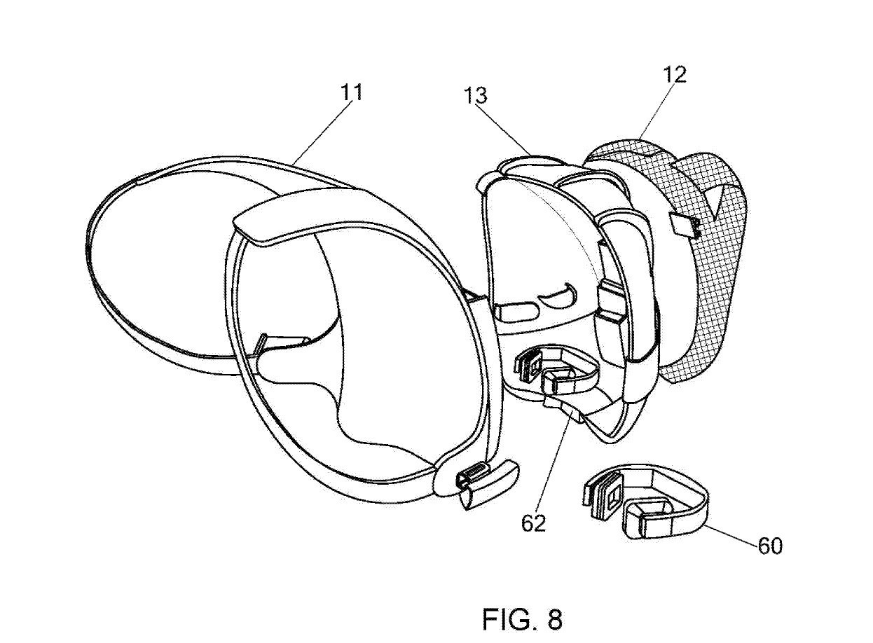

In some embodiments, the bag 10 may include a built-in rechargeable wireless speaker 18, such as a Bluetooth® speaker. In some embodiments, the wireless speaker 18 may be removable form the bag 10 for portable use or may be retained in the bag 10 with sound being emitted therefrom. In some embodiments, in addition to or in substitution of the wireless speaker 18, one or more sets of wireless headphones 60 may be built into the bag 10 as shown in FIG. 8, or one or more sets of wired headphones or earbuds 52 may extend from the bag 10 as shown in FIG. 7. FIGS. 5A and 5B show one exemplary positioning of the wireless speaker 18 in a pocket 42 formed along one of the straps 15 extending from the bag 10.

The bag 10 can include features to transform the bag 10 to a Wi-Fi hotspot. For example, the bag 10 can include a subscriber identity module (SIM) slot 22 configured to receive a SIM (not shown) therein. The SIM can be used to connect to a wireless data connection, such as 3G, 4G, LTE, or the like. The user may pre-pay for data via the SIM or may subscribe. In some embodiments, the bag 10 may include multiple SIM ports 22 for connecting SIM cards from various countries. In this embodiment, the bag 10 may include various features similar to those found in a mobile smart phone. The bag 10 may include a processor and software to allow access to the SIM and to permit data to be sent and received therethrough. In this embodiment, the bag 10 may include a wireless data sender/receiver (shown generally at 34, as its position may vary), so that the bag 10 may act as a wireless hotspot to permit a plurality of mobile devices to connect therethrough. The bag 10 may include a display for choosing SIM connectivity, or the like. In some embodiments, programming of the SIM connectivity may be achieved via software on a separate device, such as a smart phone, that may communicate with the bag 10 via a wireless signal.

In some embodiments, the bag 10 can include a method for charging electronic devices. The bag 10 can include a power supply 32, such as a rechargeable battery pack, with one or more ports 28 electrically connected thereto. In some embodiments, the battery pack may be a removable battery pack, permitting separation of the bag and the battery as may be required for air travel or the like. The ports 28 can be, for example, universal serial bus (USB) ports. In some embodiments, docking stations may be disposed in the bag for directly connecting electrical devices. In some embodiments, the solar panels 12 may be disposed on the outside of the bag 10 or may be stored within the bag 10 and removable therefrom, for charging the battery pack. For example, an outer strap like design, as shown in FIG. 1, may be formed from flexible solar panels 12 that may be on the exterior of the bag 10 to capture solar energy when the bag 10 is work or placed on a surface, for example.

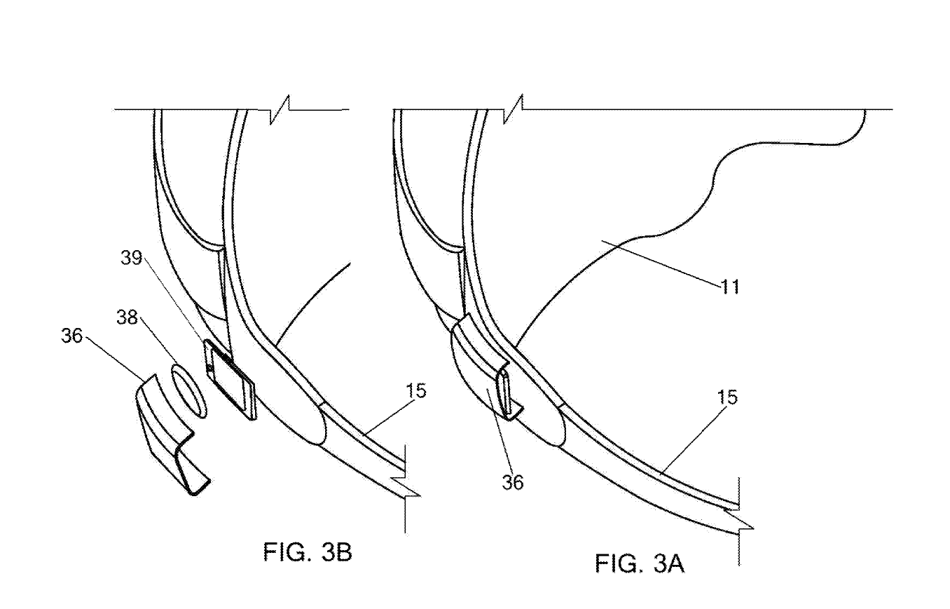

In some embodiments, the bag 10 may charge certain electronic devices via wireless or near field communication (NFC) technologies. For example, FIGS. 3A and 3B show a smartphone pocket 36 formed in the bag 10 where the phone 39 may be charged through wireless charging technology 38. The charging circuit may connect to the battery 32 of the bag 10 (which may be charged through the solar panels 12, through an energy producing material, such as a smart textile that changes movements into power, a kinetic energy power conversion device, or the like) or may connect to a separate rechargeable battery, for example. In some embodiments, an inverter (shown generally at 24) may be used to convert DC power from the battery 32 to AC power delivered to an AC socket 26.

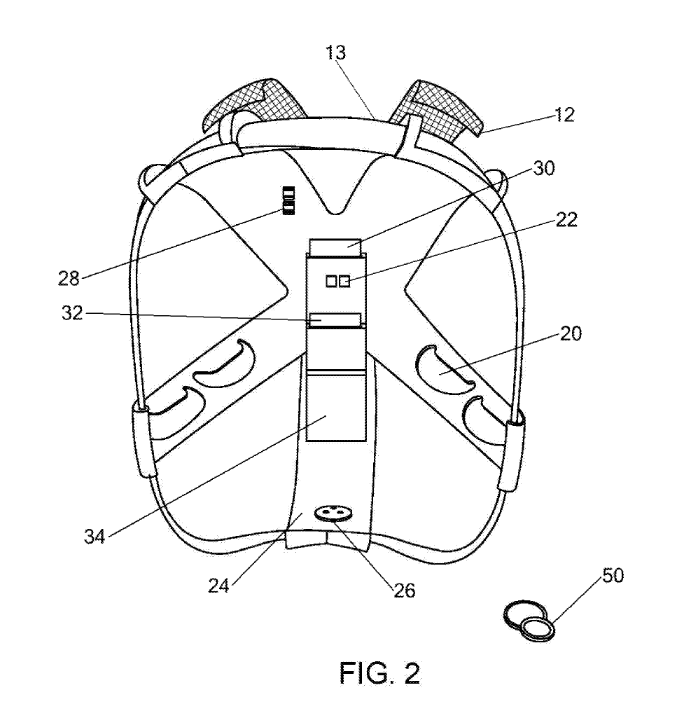

The bag 10 can include various security features, such as hidden compartments, alarms, cut proof materials, water proof materials, RFID blocking, or the like. In some embodiments, a portion or all of the bag may be formed from a bullet-proof material. A GPS feature may be integrated into the bag for locating the bag if lost or for sounding an alarm when the bag is detected at a location a predetermined distance from the user. In some embodiments, as shown in FIG. 2, a key chain 50 may be carried by the user that may sound an alarm when the bag 10 is beyond a predetermined distance from the key chain 50.

The bag 10 may include spaces for various electronic devices, such as spaces for a tablet, a laptop, a mobile phone, business cards, cords/wires, and the like. The bag may include one or more of these spaces.

The bag 10 may include the ability to store data. In this embodiment, the bag 10 may include storage 30, such as a hard drive, cloud storage, solid state hard drive, removable storage, or the like. The storage 30 may be programmed to perform various tasks. For example, the bag 10 may be configured to automatically retrieve data from a device connected thereto and back up that data to the bag's storage device. This data can include photos, videos, documents, and the like.

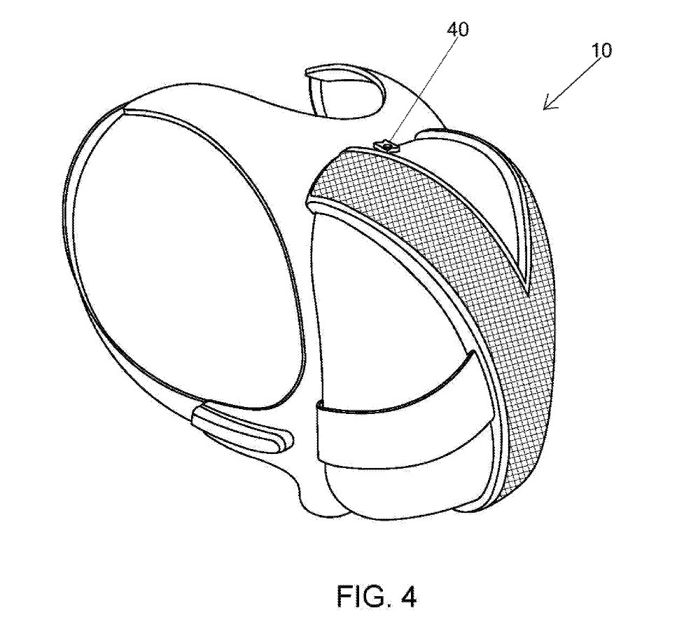

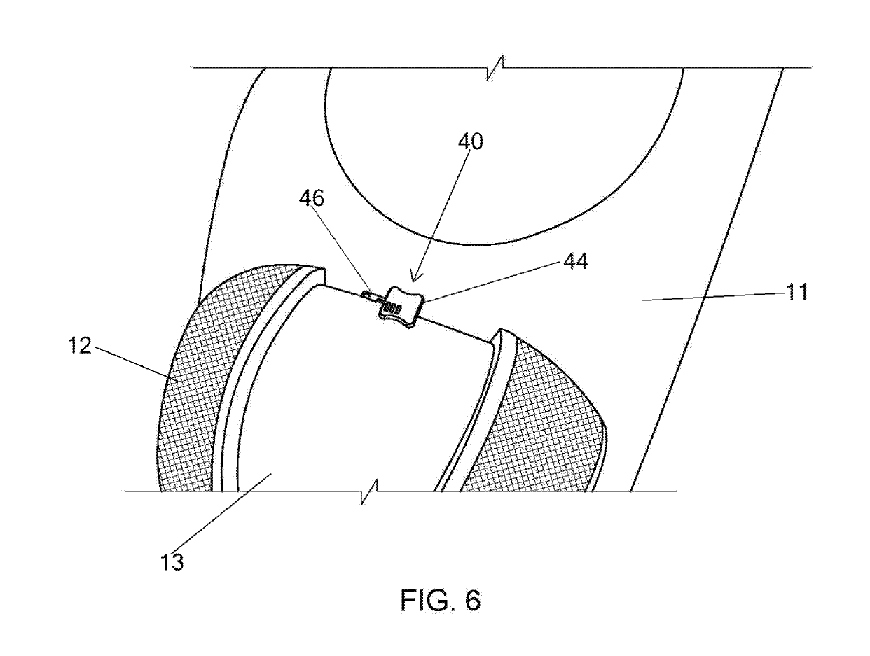

As shown in FIGS. 4 and 6, The bag 10 may be closed by one or more zippers 40, such as those described in PCT/US18/38630, the contents of which are herein incorporated by reference. In some embodiments, a single enclosure may be closed by two zipper pulls that meet when the bag is closed. In this embodiment, one of the zipper pulls may be a lock 44, where the other of the zipper pulls 46 fits therein. This allows the zipper to lock without having an additional, hanging zipper attached to the zipper pulls. The lock can be formed to be opened and closed by various mechanisms. For example, once locked, the lock may be opened by a wireless device, such as a wireless connected mobile phone, a combination, a key, a biometric scan, or the like. The lock itself may be formed in various types, as may be known in the art. In some embodiment, the zipper pulls may be magnetized to help secure the ends together.

In some embodiments, the zipper may be a self-closing zipper, where the zipper can automatically close with the touch of a button, for example. In some embodiments, the zipper may automatically close after a given period of time of inactivity of the bag, or if the bag moves outside a predetermined distance away from a user. In this embodiment, the zipper may self-close and may remain closed until the user sends a signal to the bag to release the zipper. This feature may be both a convenience and a security feature for the bag.

The zipper may have a combination lock that may also be opened with a key, thus making the lock TSA-approved.

Other features may be incorporated into the smart bag of the present invention. For example, a locator device may be placed on items to be stored in the bag, where, if one or more of these items are not present in the bag, the bag may send alert to a user, such a push alert to a user's mobile computing device, to let the user know of one or more missing items.

The bag may include various lighting options, including interior lighting, downward facing lighting, accent lighting or the like. The bag may further include one or more cameras, such as a rear-facing camera, side view cameras or the like. These cameras may interact with a user's computing device to display a view from one or more of these cameras. In some embodiments, a motion detector may be incorporated with one or more cameras and detection zones may be set up to alert the user (via, for example, a push alert to a user's mobile computing device), when motion is detected within the detection zones. In other embodiments, the user may choose to view a live view on their mobile device, allowing a user to see behind them or to their sides via their mobile computing device, such as their smart phone, while wearing the bag as a backpack. All the features disclosed in this specification, including any accompanying abstract and drawings, may be replaced by alternative features serving the same, equivalent or similar purpose, unless expressly stated otherwise. Thus, unless expressly stated otherwise, each feature disclosed is one example only of a generic series of equivalent or similar features.

Many alterations and modifications may be made by those having ordinary skill in the art without departing from the spirit and scope of the invention. Therefore, it must be understood that the illustrated embodiments have been set forth only for the purposes of examples and that they should not be taken as limiting the invention as defined by the following claims. For example, notwithstanding the fact that the elements of a claim are set forth below in a certain combination, it must be expressly understood that the invention includes other combinations of fewer, more or different ones of the disclosed elements.

The words used in this specification to describe the invention and its various embodiments are to be understood not only in the sense of their commonly defined meanings, but to include by special definition in this specification the generic structure, material or acts of which they represent a single species. The definitions of the words or elements of the following claims are, therefore, defined in this specification to not only include the combination of elements which are literally set forth. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptually equivalent, what can be obviously substituted and also what incorporates the essential idea of the invention.

What is claimed is:

1. A bag comprising:
a first member mating with a second member forming a space therebetween;
an openable closure providing access to the space;
at least one power storage apparatus removably configured in the bag;
one or more charging devices configured to charge the at least one power storage apparatus;
one or more power ports outputting power from the at least one power storage apparatus.

2. The bag of claim 1, further comprising:
one or more wireless charging modules disposed adjacent a mobile device pocket, the one or more wireless charging modules operable to charge a mobile device disposed in the mobile device pocket.

3. The bag of claim 1, further comprising an inverter converting DC power to AC power accessible from an AC power plug disposed in the bag.

4. The bag of claim 1, wherein the one or more charging devices includes at least one of a solar panel, a kinetic energy power conversion device and an energy producing textile.

5. The bag of claim 4, wherein the solar panel is a flexible solar panel disposed on an outer surface of the outer member of the bag.

6. The bag of claim 1, further comprising a storage device.

7. The bag of claim 6, wherein the storage device is programmed to automatically backup one or more electronic devices disposed in the bag.

8. The bag of claim 1, further comprising a wireless transmitter and receiver operable to connect to a wireless signal.

9. The bag of claim 8, wherein the wireless signal transmits data between the bag and a mobile computing device.

10. The bag of claim 1, further comprising one or more subscriber identity module (SIM) ports operable to receive a SIM card therein.

11. The bag of claim 10, further comprising software for accessing the SIM card to send or receive data.

12. The bag of claim 1, further comprising a locking zipper enclosing the first member with the second member.

13. The bag of claim 1, further comprising a proximity alert device providing an alert to a user when the bag is beyond a preconfigured distance from the proximity alert device.

14. A bag comprising:
an inner member mating with an outer member forming a space therebetween;
an openable closure providing access to the space;
at least one power storage apparatus removably configured in the bag;
one or more charging devices configured to charge the at least one power storage apparatus;
a wireless communication module in the bag to permit wireless data to be sent to and from the bag; and
a data storage device electronically connected to a controller in the bag, wherein
the controller permits data to be stored in or accessed from the data storage device.

15. The bag of claim 14, wherein the data is backup data for one or more electronic devices connected to exchange the data with the data storage device.

16. The bag of claim 14, wherein the data is music data deliverable to a user via at least one of a wireless speaker, a wireless headphone or a wired headphone.

17. The bag of claim of claim 14, further comprising one or more subscriber identity module (SIM) ports operable to receive a SIM card therein and software for accessing the SIM card to send or receive data.

18. A bag comprising:
an inner member mating with an outer member forming a space therebetween;
an openable closure providing access to the space;
at least one power storage apparatus removably configured in the bag;
one or more charging devices configured to charge the at least one power storage apparatus;
one or more power ports outputting power from the at least one power storage apparatus;
one or more wireless charging modules disposed adjacent a mobile device pocket, the one or more wireless charging modules operable to charge a mobile device disposed in the mobile device pocket;
one or more data storage devices electronically connected with a processor in the bag;
a wireless transmitter and receiver operable to connect to a wireless signal; and
a proximity alert device providing an alert to a user when the bag is beyond a preconfigured distance from the proximity alert device.

19. The bag of claim 18, wherein the one or more charging devices includes a solar panel.

20. The bag of claim 18, further comprising a locking zipper enclosing the inner member with the outer member.

21. The bag of claim of claim 18, further comprising one or more subscriber identity module (SIM) ports operable to receive a SIM card therein and software for accessing the SIM card to send or receive data.
